(19) United States
(12) Patent Application Publication
(10) Pub. No.: US 2008/0235267 A1
(43) Pub. Date: Sep. 25, 2008

(54) Method and Apparatus For Automatically Generating a Playlist By Segmental Feature Comparison

(75) Inventors: Javier Francisco Aprea, Eindhoven (NL); Aweke Negash Lemma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/067,991

(22) PCT Filed: Sep. 1, 2006
(86) PCT No.: PCT/IB2006/053057

§ 371 Date: Mar. 25, 2008

(30) Foreign Application Priority Data
Sep. 29, 2005 (EP) 05109015.7

(51) Int. Cl. G06F 17/30

(52) U.S. Cl. 707/102; 707/E17.005

(57) ABSTRACT

A playlist of content items, e.g. songs, is automatically generated in which content items having features similar to features of a seed content item are selected. At least one feature of the seed content item is compared with at least one feature of each candidate content item to identify specific ones of the candidate content items that are similar to the seed content item. The identified candidate content items are then added to the playlist. Multiple features represent (e.g. are extracted from) different parts of a plurality of candidate content items and/or multiple features of the seed content item represent (e.g. are extracted from) different parts of the seed content item. The multiple features of the seed content item and/or of the candidate content items are compared with at least one feature of the seed content item or of the candidate content items.

### FIELD OF THE INVENTION

The present invention relates to method and apparatus for automatically generating a playlist of content items, e.g. songs. In particular, it relates to automatic playlist generation of content items similar to a seed content item.

### BACKGROUND OF THE INVENTION

Multimedia consumer devices are expanding in processing power and can provide users with more advanced multimedia content browsing, navigation and retrieval features. It is expected that due to the increase of storage capacities and connection bandwidths, consumers will have access to enormous databases of content items. Therefore, there is an increasing demand to provide effective browsing, navigation and retrieval systems to assist the user.

There are many known systems for the retrieval of content items and for automatic generation of playlists. Some of these systems operate on selecting content items from an extensive database on the basis of their similarity to a certain seed (or reference) content item. In such systems, all the content items stored in the database are pre-analysed and their representative features are stored in a metadata database. The user supplies a seed content item (which has a classification, associated therewith) and the system then retrieves similar content items by comparing the degree of similarity between the respective representative features (or similarity between the classifications of the respective content items). However, these known systems do not retrieve all content items which would be regarded by the user as similar to the seed content item.

### SUMMARY OF THE INVENTION

The present invention aims to provide a method that improves the perceived quality of the generated playlist.

This is achieved, according to an aspect of the present invention, by a method for automatically generating a playlist of candidate content items having features similar to features of a seed content item, the method comprising the steps of: comparing at least one feature of the seed content item with at least one feature of the candidate content items to identify specific ones of said candidate content items that are similar to the seed content item; and adding the identified candidate content items to the playlist, wherein the at least one feature of the seed content item and/or the at least one feature of the candidate content items comprises multiple features, the multiple features being representative of different parts of the seed content item and/or the candidate content items. The multiple features of the seed content item and/or of the candidate content items are compared with at least one feature of the seed content item or of the candidate content items.

This is also achieved, according to another aspect of the present invention, by an apparatus for automatically generating a playlist of candidate content items having features similar to features of a seed content item, the generator comprising: a comparator for comparing at least one feature of the seed content item with at least one feature of each of the candidate content items to identify specific ones of said candidate content items that are similar to the seed content item; and a compiler for adding the identified candidate content items to the playlist, wherein the at least one feature of the seed content item and/or the at least one feature of the candidate content items comprises multiple features, the multiple features being representative of different parts of the seed content item and/or the candidate content items.

For example, a composite piece of audio content item may have three distinctive portions: classical, speech and pop. Using a known classifier, this would be classified strictly as one of classical, speech or pop. As a result, a generated playlist might only contain candidate songs of this one class and/or might only contain candidate songs whose one class is similar to the class of the seed song (e.g. a candidate song with a pop part may not be listed for a seed song of class pop if the candidate song also has a classical part and only this classical part is used to compare the two songs). To overcome this, according to an embodiment of the present invention, a record is kept of, in the case of the example above, features from each portion (three sets of features): one set extracted from the classical part, one set from the speech part and one set from the pop part and, in the database, the content is linked with the three sets of features. This means that, the classifier will classify such a song as classical, speech and pop. Consequently, if the content of the content item varies greatly, it will be represented by a greater number of feature vectors which will more accurately represent the characteristics of the content as opposed to the existing systems which would attempt to represent the characteristics with a single feature vector. This results in an improved playlist of similar content items.

The feature may be a single feature, e.g. a value representing tempo or a classification, or it may be a feature vector. The method may extract the feature from a content item or from a metadata tag or database entry associated with the content item.

In a preferred embodiment, each of the plurality of candidate content items and the seed content item are segmented into a plurality of frames; and at least one feature vector is extracted from each frame to provide the multiple feature vectors of the content item.

The segmentation provides a pre-processing step and the feature vector can be extracted using an existing classifier. Therefore, no modification of the classifier is required.

### BRIEF DESCRIPTION OF DRAWINGS

For a more complete understanding of the present invention, reference is made, as example, to the following description taken in conjunction with the accompanying drawings, in which:

FIG. 1 illustrates steps of the method according to a first embodiment of the present invention;

FIG. 2 illustrates the steps of the method according to a second embodiment of the present invention; and

FIG. 3 graphically illustrates the distribution of the feature vectors extracted according to a third embodiment of the present invention.

### DETAILED DESCRIPTION OF PREFERRED EMBODIMENTS

For the purposes of the describing the embodiments, only the extraction of feature vectors of the audio content of the content item will be described. However, it can be appreciated that the method could be applicable for the extraction of features of the remaining content of the content item. The content item may comprise a file of analog or digital multimedia contents, music tracks, songs and the like.

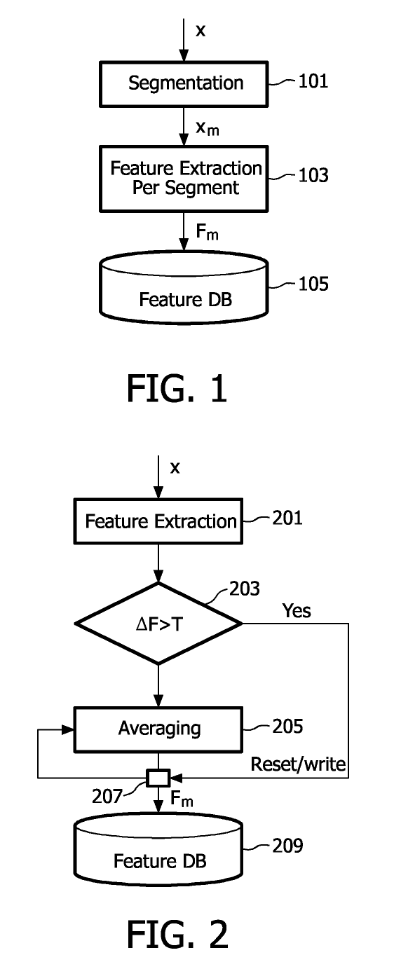

The method according to a first embodiment will now be described with reference to FIG. 1. The incoming audio x is first segmented into frames xₘ of arbitrarily chosen length, step 101. The length of the frames may be of the same predetermined length or may be varied randomly. For each audio segment (or frame) xₘ, a feature vector is extracted using known techniques, step 103 and stored in a feature database, step 105.

Let M≧1 be the number of segments in the candidate content item (song) and K≧1 be the number of segments in the seed content item (song). Moreover, let F_{s, k} and F_{j, m} be the feature vectors corresponding to the k-th and m-th segments of the seed and the candidate songs, respectively. Then during playlist generation the distance D(Fₛ, Fⱼ) between the segmented seed song (denoted by s) and the segmented candidate song (denoted by j) is given by

$$D ( {F}_{s} , {F}_{j} ) = {min}_{{m = 1 … M}_{k = 1 … K}} ( {F}_{s , k} - {F}_{j , m} )$$

A number of candidate songs may be selected which meet predetermined distance criteria. These can be listed in the playlist in order of ascending distance, for example. The user can then select the top (say 30) matches to create the playlist. Alternatively, a maximum threshold for D(Fₛ, Fⱼ) can be predetermined and only those content items (songs) that have distances below the threshold are selected for the playlist.

In the second embodiment, segmentation is achieved by comparing the instantaneous change in feature vector. A simple schematic of this embodiment is shown in FIG. 2. This is achieved by continuously averaging, step 205, the feature vector extracted in step 201 until the instantaneous change in feature statistics exceeds a certain threshold T, in step 203. Whenever this happens, a segmentation boundary is set the averaging buffer is reset 207 and the segment feature vector is written to the feature database, step 209. This procedure is repeated until the end of the song is reached. The advantage of this approach is that it provides a better trade-off between the number of features per song and representativeness of the features. The instantaneous change can be calculated in several ways. Some examples are instantaneous change are change in the local mean, drifting monitoring etc.

Again as described with reference to the first embodiment, a number of candidate songs may be selected which meet predetermined distance criteria to generate the playlist.

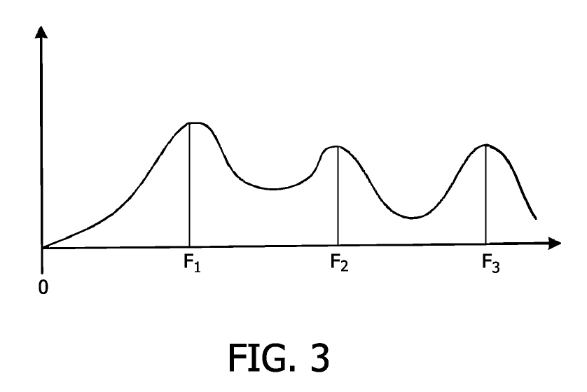

In a third embodiment, feature vectors are extracted and representative feature vectors are determined by analyzing the distribution of the vectors. A simple example of such a distribution is shown in FIG. 3.

In this case, the features F1, F2 and F3 are taken as representative ones. In this way song segmentation is not required. The method according to this embodiment simply looks at the statistics and takes the local maxima as representative features. If there are several local maxima, multiple representative features are extracted. If there is only one maximum then the song will have only one representative feature.

Again as described with reference to the first embodiment, a number of candidate songs may be selected which meet predetermined distance criteria to generate the playlist. As a result, in this procedure randomization of playlist can be obtained by randomly choosing from the representative features. This way a more accurate (noise free) randomized playlist is achievable.

Although preferred embodiments of the present invention have been illustrated in the accompanying drawings and described in one foregoing detailed description, it will be understood that the invention is not limited to the embodiments disclosed, but is capable of numerous modifications without departing from the scope of the invention as set out in the following claims.

1. A method for automatically generating a playlist of candidate content items having features similar to features of a seed content item, the method comprising the steps of:
comparing at least one feature of the seed content item with at least one feature of the candidate content items to identify specific ones of said candidate content items that are similar to the seed content item; and
adding the identified candidate content items to the playlist,
wherein the at least one feature of the seed content item and/or the at least one feature of the candidate content items comprises multiple features, the multiple features being representative of different parts of the seed content item and/or the candidate content items.

2. A method according to claim 1, further comprising the steps of:
segmenting each of the plurality of candidate content items and/or the seed content item into a plurality of frames;
extracting at least one feature from each frame to provide the multiple features of the content item.

3. A method according to claim 2, wherein the frames are of a predetermined length.

4. A method according to claim 3, wherein each frame is of equal length.

5. A method according to claim 2, wherein the segmentation is on the basis of the content of the candidate content items and/or the seed content item.

6. A method according to claim 2, wherein the boundaries of said plurality of frames are determined by the instantaneous changes in the features of the said candidate content items and/or the seed content item.

7. A method according to claim 1, wherein the step of comparing at least one feature of the seed content item with at least one feature of the candidate content items further comprises:
the step of determining the distance between the features and the step of selecting at least one candidate content item having the smallest distance to be added to the playlist.

8. An apparatus for automatically generating a playlist of candidate content items having features similar to features of a seed content item, the generator comprising:
a comparator for comparing at least one feature of the seed content item with at least one feature of each of the candidate content items to identify specific ones of said candidate content items that are similar to the seed content item; and
a compiler for adding the identified candidate content items to the playlist,
wherein the at least one feature of the seed content item and/or the at least one feature of the candidate content items comprises multiple features, the multiple features being representative of different parts of the seed content item and/or the candidate content items.

9. A computer program product comprising a plurality of program code portions for carrying out the method according to claim 1.
